(19) United States
(12) Patent Application Publication
(10) Pub. No.: US 2007/0150421 A1
(43) Pub. Date: Jun. 28, 2007

(54) NETWORKED FRANKING SYSTEM WITH FACILITATED MAINTENANCE

(75) Inventor: Fabien Chatte, Nogent Sur Marne (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST Technologies, Bagneux (FR)

(21) Appl. No.: 11/468,436

(22) Filed: Aug. 30, 2006

(30) Foreign Application Priority Data
Aug. 31, 2005 (FR) 0508911

(51) Int. Cl. G06F 17/00

(52) U.S. Cl. 705/403

(57) ABSTRACT

In a mail franking system including a franking management module (32) and at least one data processing means (34A-34D) associated with means of printing a postmark (36A-36B, 38A-38B) and connected to the franking management module via a local area network (LAN), it is provided that the franking management module includes a Web server and the data processing means includes a Web browser to access a franking management application residing on the Web server. This franking management module is a franking machine (32).

### TECHNICAL FIELD

The present invention relates exclusively to the field of mail processing and concerns more particularly a franking system the deployment and maintenance of which are made easier.

### PRIOR ART

Today, in open franking systems in which the printing of postmarks can be performed remotely from secure metering means, as in the modular franking system illustrated in U.S. Pat. No. 5,822,738 filed by the applicant, it is necessary to have at each of the computer terminals from which this franking can be accomplished a specific application with the task on one hand of providing the connection between the terminal and the metering means and, on the other hand, of retrieving from these secure metering means postal data necessary for secure printing of the postmark.

The presence of this application in the different terminals poses a serious problem of implementing and updating the franking system. Firstly, this application must be compatible with the operating system of the terminal in which it is installed. Moreover, in an open franking system comprising a large number of terminals, different operating systems (Windows®, Linux®, Mac OS®) can cohabit, hence the obligation to develop applications specially adapted for each of them. Leaving aside the fact that different versions of the same operating system (Windows for example) can prove mutually incompatible, thus calling for a specific development in this case too. Secondly, given the constant changes in postal regulations (new services, new tariffs, etc.), it is necessary to regularly update the application at each terminal, which represents a major constraint for the user, particularly in the case of a franking system comprising a substantial number of terminals.

### DISCLOSURE OF THE INVENTION

The object of the present invention is therefore to overcome the abovementioned drawbacks by proposing a novel mail franking system including a franking management module and at least one data processing means associated with means of printing a postmark and connected to said franking management module via a local area network, characterised in that said franking management module includes a Web server and said data processing means includes a Web browser to access a franking management application residing on the Web server.

Thus, by installing a Web server in the franking management module, the deployment and maintenance of the franking system is made easier.

Advantageously, the franking management module additionally includes an FTP server intended to cooperate with an FTP client installed on a remote management server.

In the embodiment envisaged, the franking management module can include a franking machine or a general purpose computer associated with a secure postage metering device.

In the embodiment envisaged, the printing means include a standard printer or a franked label dispenser.

In the embodiment envisaged, the data processing means includes a personal computer or a portable digital terminal connected to said local area network via a wireless link.

The invention also concerns a franking management module intended to cooperate over a local area network with at least one data processing means associated with means of printing postmarks, characterised in that it includes a Web server accessible from a Web browser installed on said data processing means. Advantageously, it additionally includes an FTP server intended to cooperate with an FTP client installed on a remote management server.

In the embodiment envisaged, the franking management module includes a franking machine or a general purpose computer associated with a secure postage metering device.

### BRIEF DESCRIPTION OF THE FIGURES

Other characteristics and advantages of the present invention will become more clearly apparent from the following description, provided for information and non-limitative regarding the invention, with reference to the attached drawings, in which:

FIG. 1 illustrates a first example of a franking system according to the invention,

FIG. 2 illustrates a second example of a franking system according to the invention, and

FIG. 3 illustrates the different applications needed to implement the system in FIG. 1.

### EMBODIMENT(S) OF THE INVENTION

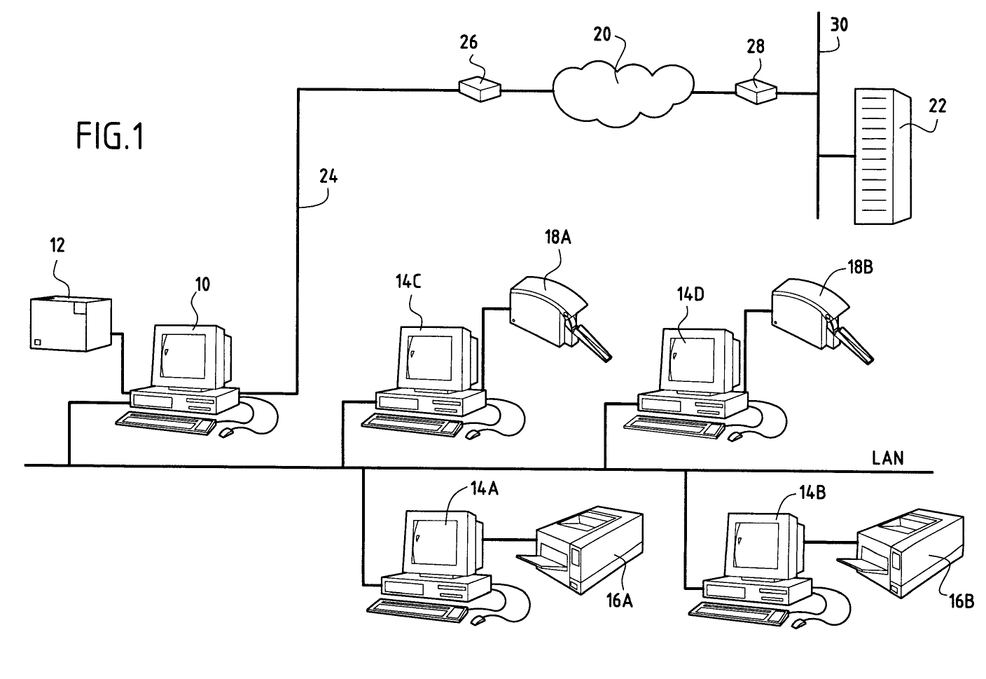

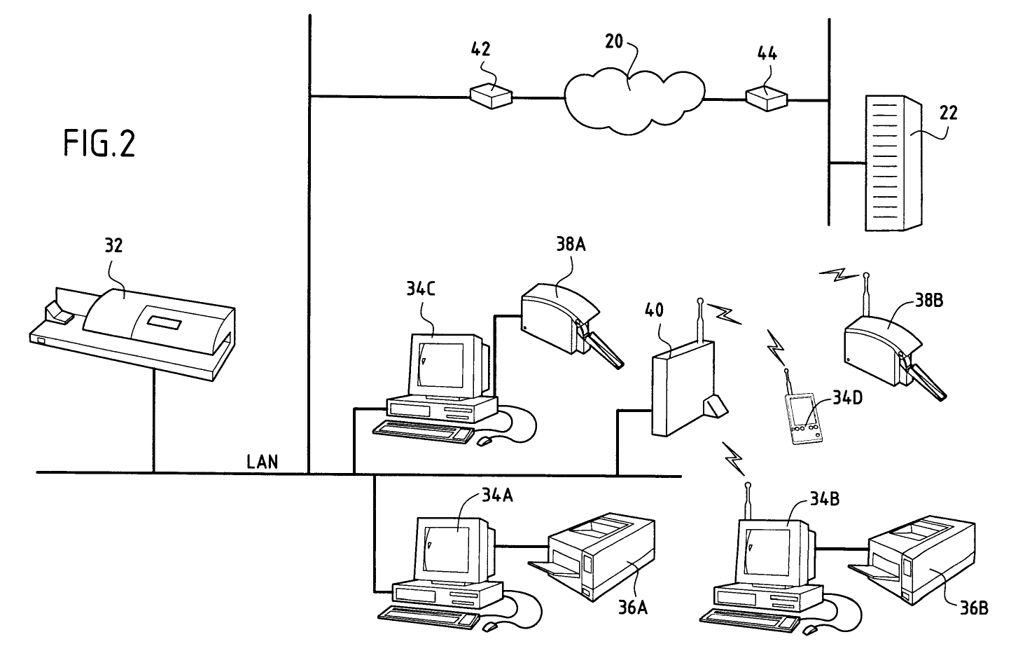

FIGS. 1 and 2 depict two franking system architectures that enable the invention to be carried out.

The first architecture illustrated in FIG. 1 relates to a modular franking system such as that described in the US Patent cited in the preamble. It is built around a user's local area network (LAN) to which are connected, on the one hand, preferably via an administration computer 10, secure postage metering means 12 (PSD “postal security device” or SMD “secure metering device”) and on the other hand various data processing devices, for example personal computers 14A to 14D. Each of these general purpose computers is itself connected either to a standard printer 16A, 16B or to a franked label dispenser 18A, 18B of the type described in patent application FR 2 829 269 filed in the applicant's name designed to facilitate secure printing of postmarks.

To facilitate loading of the metering means and statistical monitoring of frankings performed by the different printing means of the system (printer or dispenser), the administration computer 10 is connected via an external telecommunications network 20 to a remote management server 22 of the franking system operator or postal authority. This connection is provided via a dedicated link 24 and specific interfaces (modem 26, 28). The management server can additionally be connected to the telecommunications network directly or via its own local area network 30.

FIG. 2 illustrates a second franking system architecture in which the secure postage metering means are no longer independent of but integrated with a standard franking machine 32 connected to the local area network (LAN) of the user. Various data processing devices, for example personal computers 34A to 34C and a portable digital terminal 34D are also connected to this local area network. Each of these general purpose computers or terminal is itself connected either to a standard printer 36A, 36B or to a franked label dispenser 38A, 38B. In the example illustrated, the computer 34B and the portable terminal 34D are connected to the local area network 10 via a wireless modem/router 40, the portable terminal 34D controlling the franked label dispenser 38B also via a wireless link.

In the example illustrated, the user's local area network is connected, via a first modem/router 42, to the external telecommunications network 20 to which the remote management server 22 of the franking machine operator or postal authority is connected, via a second modem/router 44. In an alternative configuration, the link with the remote management server 22 may be provided by means of a dedicated link (not shown) connected directly to the franking machine 32 without passing through the user's local area network.

According to the invention, to avoid the compatibility and maintenance problems of the prior art related to the presence in each data processing device, computer or terminal, of a specific application controlling the printing of postmarks, provision is made to install in the franking machine 32 or in the administration computer 10 a Web server to which each data processing device can then have access via a simple Web browser installed in each device.

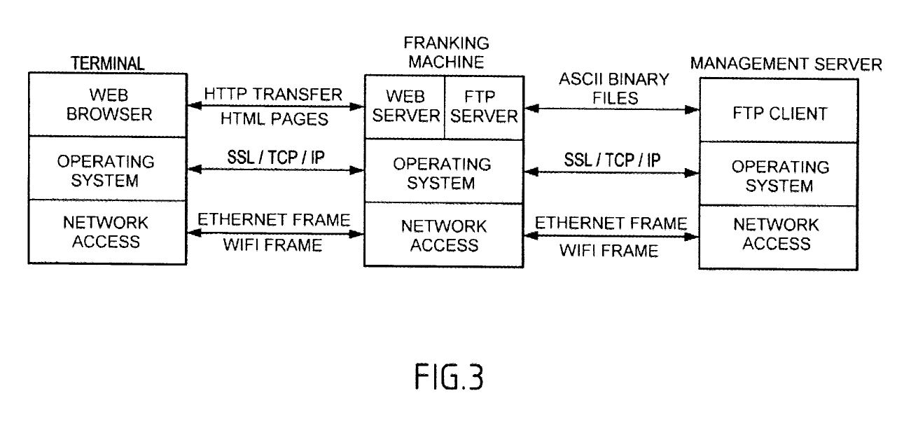

The software architecture necessary for the implementation of this embedded Web server is illustrated in FIG. 3 which shows the arrangement of the different applications and their interaction at the level of the franking system. This software architecture is described with reference to the multi-layered model known by the designation OSI model (Open System Interconnection).

Attention is directed in the first instance to the franking machine (or to the administration computer). At the level of the first and second layers (physical and link layers) of the OSI model, this includes a standard network access application enabling an exchange of Ethernet or WiFi frames over the LAN network and with the management server. At the level of the third, fourth and fifth layers (network, transport and session layers), it includes the operating system which can be of any origin, for example Windows CE®, embedded Linux®, etc. Finally, at the level of the last two layers (presentation and application layers), it includes the Web server, for example a mini apache®, and an FTP server to enable the Web server to be updated from the remote management server 22.

Similarly, the personal computer or the portable digital terminal also includes at the level of the first and second layers (physical and link layers of the OSI model) a standard network access application enabling an exchange of Ethernet or WiFi frames over the LAN network. At the level of the third, fourth and fifth layers (network, transport and session layers), it includes its operating system which can here again be of any origin and depends on the type of device, for example Windows®, MAC OS®, Linux®, etc. for a personal computer, or Windows CE® for a portable terminal for example. Finally, at the level of the last two layers (presentation and application layers), it includes the Web browser, for example Internet Explorer®, Firefox®, Opera®, etc. to access the Web server via an HTML page transfer.

A similar architecture is found at the level of the remote management server 22 with, at the level of the first and second layers, a standard network access application enabling an exchange of Ethernet or WiFi frames with the franking machine (or the administration computer depending on the configuration envisaged). At the level of the third, fourth and fifth layers, the server includes its own operating system which can of course be of any origin, for example Unix®, Linux®, Windows®, etc. Finally, at the level of the last two layers, an FTP Client enables the updating or addition of Web pages on the Web server by transfer of binary or ASCII files with the FTP server installed in the franking machine (or the administration computer).

The operation of the franking system is as follows. When the user wishes to print a postmark on a printer or a franked label dispenser at his/her disposal, he/she will first of all cause the Web browser to be displayed on the screen of the computer or terminal associated with the printing means, and will then enter in the address bar of this browser the IP address of the franking machine or of the administration computer on which the printing management Web server is installed. This operation, which can of course be automated and performed by a simple click on a specific icon present on the computer or terminal screen, will establish a secure connection (SSL connection) between this terminal and the franking machine. In response, the franking machine or the administration computer will display its home page on the requesting user's computer or terminal, thereby giving the user access, optionally after authentication by a username and password, to the different functions enabling the user to print one or more postmarks, such as determination of destination, choice of postage class or postage type (traceable delivery, registered delivery), etc. This home page can also provide the user with a range of franking-related services such as the choice of a logo, provision of mailing statistics, etc.

Thus, with the franking system of the invention:

communications with the data processing devices are standardised according to the known HTTP protocol, irrespective of the operating system used by each of the devices,

maintenance no longer needs to be performed at the level of each data processing device but simply at the level of the franking machine or the computer on which the Web server resides,

the development of new services no longer requires the installation of new applications at the level of each data processing device but a simple addition of new application pages on the Web server, this addition being able to be implemented remotely via the FTP server.

1. Mail franking system including a franking management module (10-12; 32) and at least one data processing means (14A-14D; 34A-34D) associated with means of printing a postmark (16A-16B, 18A-18B; 36A-36B, 38A-38B) and connected to said franking management module via a local area network (LAN), wherein said franking management module includes a Web server and said data processing means includes a Web browser to access a franking management application residing on the Web server.

2. System according to claim 1, wherein the franking management module additionally includes an FTP server intended to cooperate with an FTP client installed on a remote management server (22).

3. System according to claim 1, wherein said franking management module includes a franking machine (32).

4. System according to claim 1, wherein said franking management module includes a general purpose computer (10) associated with a secure postage metering device (12).

5. System according to claim 1, wherein said printing means include a standard printer (16A-16B; 36A-36B).

6. System according to claim 1, wherein said printing means include a franked label dispenser (18A-18B; 38A-38B).

7. System according to claim 1, wherein said data processing means includes a personal computer (14A-14D; 34A-34C).

8. System according to claim 1, wherein said data processing means includes a portable digital terminal (34D) connected to said local area network via a wireless link.

9. Franking management module intended to cooperate over a local area network (LAN) with at least one data processing means (14A-14D; 34A-34D) associated with means of printing postmarks (16A, 16B, 18A, 18B; 36A, 36B, 38A, 38B), wherein it includes a Web server accessible from a Web browser installed on said data processing means.

10. Franking management module according to claim 9, wherein it additionally includes an FTP server intended to cooperate with an FTP client installed on a remote management server (22).

11. Franking management module according to claim 9, wherein said franking management module includes a franking machine (32).

12. Franking management module according to claim 8, wherein said franking management module includes a general purpose computer (10) associated with a secure postage metering device (12).

13. Franking management module according to claim 10, wherein said franking management module includes a franking machine (32).

14. Franking management module according to claim 9, wherein said franking management module includes a general purpose computer (10) associated with a secure postage metering device (12).
